(19) United States
(12) Patent Application Publication
(10) Pub. No.: US 2020/0257371 A1
(43) Pub. Date: Aug. 13, 2020

(54) GESTURE INTERFACE SYSTEM OF VEHICLE AND OPERATION METHOD THEREOF

(71) Applicants: Hyundai Motor Company, Seoul (KR); KIA Motors Corporation, Seoul (KR)

(72) Inventor: Yu Kyoung SUNG, Incheon (KR)

(73) Assignees: Hyundai Motor Company; Kia Motors Corporation

(21) Appl. No.: 16/448,172

(22) Filed: Jun. 21, 2019

(30) Foreign Application Priority Data
Feb. 13, 2019 (KR) 10-2019-0016589

(51) Int. Cl. G06F 3/01; G06T 7/70

(52) U.S. Cl. CPC G06F 3/017; G06T 7/70; G06F 3/04817; G06T 2207/30268; G06T 2207/30196

(57) ABSTRACT

A gesture interface system of a vehicle is provided. The gesture interface system includes a posture detector configured to detect a posture of a user, a gesture detector configured to detect a gesture of the user, an actuator configured to adjust a monitoring region of the gesture detector, and a controller configured to control the actuator based on the posture of the user, the posture being detected by the posture detector.

### CROSS-REFERENCE TO RELATED APPLICATION

This application claims the benefit of and priority to Korean Patent Application No. 10-2019-0016589, filed on Feb. 13, 2019, the entire contents of which are incorporated herein by reference.

### FIELD

The present disclosure relates to a gesture interface system loaded into an autonomous vehicle and an operation thereof.

### BACKGROUND

The statements in this section merely provide background information related to the present disclosure and may not constitute prior art.

In general, a user (a person who sits in the driver's seat) in an autonomous vehicle to which autonomous driving technology is applied takes a very comfortable posture, because he or she is not involved in driving the autonomous vehicle when a specific situation does not occur.

Because a hand of the user does not come into contact with an input module of the autonomous vehicle in such a posture, the user sits up to control various control systems and an infotainment system. To reduce inconvenience, a gesture interface system for recognizing a gesture of the user is applied to the autonomous vehicle.

However, the general gesture interface system of the autonomous vehicle has a gesture detector for detecting a gesture by the hand of the user. Because a monitoring region (a gesture detection region) of such a gesture detector is fixed, the gesture detector is unable to receive a gesture because the hand of the user does not come into contact with the monitoring region of the gesture detector when the user sits in a comfortable position (e.g., a position where the user leans back and is almost in a supine position) rather than a correct posture.

### SUMMARY

One aspect of the present disclosure provides a gesture interface system of an autonomous system for adjusting a monitoring region of a gesture detector in consideration of a location and/or posture of the user in the autonomous vehicle to receive a gesture irrespective of whether a user takes any posture and an operation method thereof.

According to an aspect of the present disclosure, an apparatus may include: a posture detector configured to detect a posture of a user, a gesture detector configured to detect a gesture of the user, an actuator configured to adjust a monitoring region of the gesture detector, and a controller configured to control the actuator based on the posture of the user, the posture being detected by the posture detector.

The apparatus may further include a storage device storing a table which stores direction information of the gesture detector, the direction information corresponding to the posture of the user.

The posture of the user may be a posture relative to a shoulder position of the user.

The gesture of the user may be a gesture for controlling a behavior of the vehicle. The gesture of the user may be a gesture for manipulating an infotainment system, when the infotainment system included in the vehicle is operating.

The posture detector may be mounted on a dashboard at the driver's seat of the vehicle. The posture detector may include a camera configured to capture an image of the user and an ultrasonic sensor configured to detect a distance from a shoulder of the user.

The gesture detector may be a three-dimensional (3D) air gesture detector based on ultrasound haptic technologies.

The actuator may include a first motor configured to adjust the monitoring region of the gesture detector in a left/right direction and a second motor configured to adjust the monitoring region of the gesture detector in an upward/downward direction.

The apparatus may further include a display device configured to display a function controlled by the gesture of the user in the form of an icon.

According to another aspect of the present disclosure, an apparatus may include: a seat position detector configured to detect a position of the driver's seat, a gesture detector configured to detect a gesture of a user, an actuator configured to adjust a monitoring region of the gesture detector, and a controller configured to estimate a posture of the user based on the position of the driver's seat, the position being detected by the seat position detector, and control the actuator based on the estimated posture of the user.

The apparatus may further include a storage device storing a first table which stores information about a posture of the user, the posture corresponding to the position of the driver's seat and a second table which stores direction information of the gesture detector, the direction information corresponding to the posture of the user.

The posture of the user may be a posture relative to a shoulder position of the user.

The actuator may include a first motor configured to adjust the monitoring region of the gesture detector in a left/right direction and a second motor configured to adjust the monitoring region of the gesture detector in an upward/downward direction.

According to another aspect of the present disclosure, a method may include: detecting, by a posture detector of the gesture interface system, a posture of a user, and controlling, by a controller of the gesture interface system, the actuator to set a monitoring region of a gesture detector of gesture interface system, the monitoring region corresponding to the detected posture of the user.

The method may further include storing, by a storage device of the gesture interface system, a table which stores direction information of the gesture detector, the direction information corresponding to the posture of the user.

The posture of the user may be a posture relative to a shoulder position of the user.

The gesture of the user may be a gesture for controlling a behavior of the vehicle. The gesture of the user may be a gesture for manipulating an infotainment system, when the infotainment system included in the vehicle is operating.

The method may further include adjusting, by the actuator, the monitoring region of the gesture detector in a left/right direction based on the detected posture of the user and adjusting, by the actuator, the monitoring region of the gesture detector in an upward/downward direction based on the detected posture of the user.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of a gesture interface system of an autonomous vehicle according to an aspect of the present disclosure;

FIGS. 2A, 2B, and 2C are drawings illustrating a plurality of gesture detection regions set by a gesture interface system of an autonomous vehicle according to an aspect of the present disclosure;

FIG. 3 is a block diagram illustrating a detailed configuration of a gesture detector included in a gesture interface system of an autonomous vehicle according to an aspect of the present disclosure;

FIGS. 4A and 4B are drawings illustrating display screens when a gesture interface system of an autonomous system controls a behavior of a vehicle according to an aspect of the present disclosure;

FIGS. 5A and 5B are drawings illustrating display screens when a gesture interface system of an autonomous vehicle controls an infotainment system according to an aspect of the present disclosure;

FIG. 6 is a flowchart illustrating an operation method of a gesture interface system of an autonomous vehicle according to an aspect of the present disclosure; and

FIG. 7 is a block diagram illustrating a computing system for executing an operation method of a gesture interface system of an autonomous vehicle according to an aspect of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some aspects of the present disclosure will be described in detail with reference to the drawings. In adding the reference numerals to the components of each drawing, it should be noted that the identical or equivalent component is designated by the identical numeral even when they are displayed on other drawings. Further, in the present disclosure, a detailed description of well-known features or functions may be omitted in order not to obscure the gist of the present disclosure.

In describing the components of the aspect according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

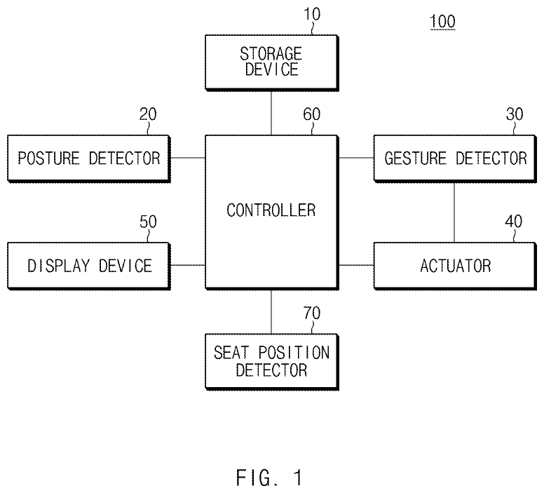

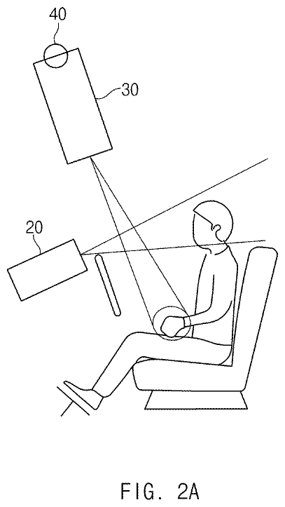

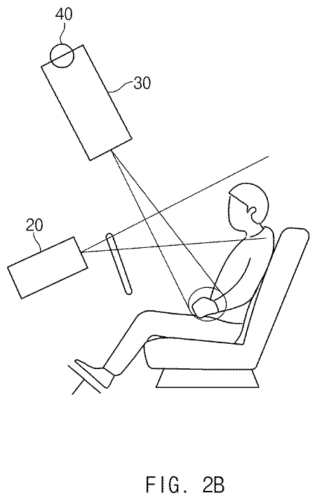

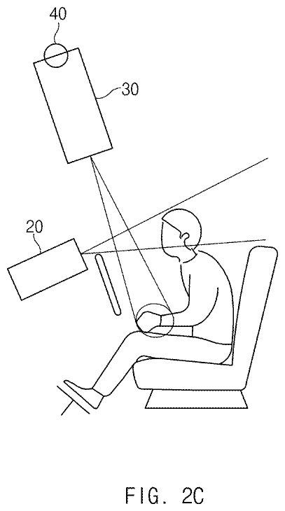

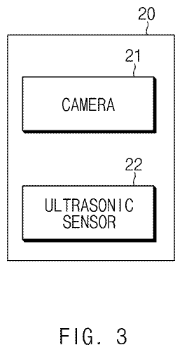

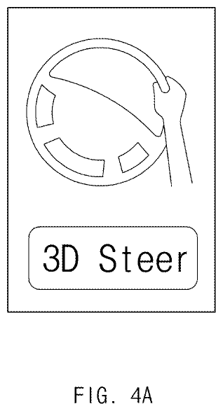

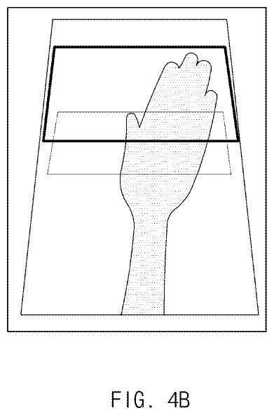

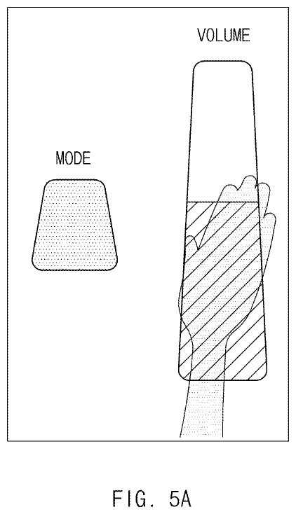

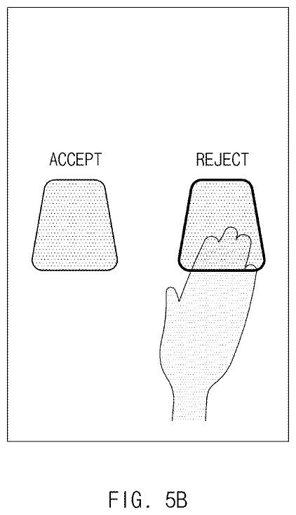

FIG. 1 is a block diagram illustrating a configuration of a gesture interface system of an autonomous vehicle according to an aspect of the present disclosure. FIGS. 2A to 2C are drawings illustrating a plurality of gesture detection regions set by a gesture interface system of an autonomous vehicle according to an aspect of the present disclosure. FIG. 3 is a block diagram illustrating a detailed configuration of a gesture detector included in a gesture interface system of an autonomous vehicle according to an aspect of the present disclosure. FIGS. 4A and 4B are drawings illustrating display screens when a gesture interface system of an autonomous system controls a behavior of a vehicle according to an aspect of the present disclosure. FIGS. 5A and 5B are drawings illustrating display screens when a gesture interface system of an autonomous vehicle controls an infotainment system according to an aspect of the present disclosure.

As shown in FIG. 1, a gesture interface system 100 of an autonomous vehicle according to an aspect of the present disclosure may include a storage device 10, a posture detector 20, a gesture detector 30, an actuator 40, a display device 50, a controller 60, and a seat position detector 70. Meanwhile, the respective components may be combined with each other to form one component depending on a manner which executes the gesture interface system of the autonomous vehicle according to an aspect of the present disclosure, and some components may be omitted according to a manner which executes an aspect of the present disclosure.

Seeing the respective components, first of all, the storage device 10 may store various logics, algorithms, and programs to adjust a monitoring region of the gesture detector 30 in consideration of a location of a user in the autonomous vehicle.

Furthermore, the storage device 10 may store a table which stores direction information (e.g., an x- and y-axis rotational angle) of the gesture detector 30, corresponding to a posture of the user, detected by the gesture detector 20. In this case, the posture of the user may be, for example, a shoulder position (x- and y-axis coordinates) of the user. Herein, the shoulder of the user may be a left shoulder or a right shoulder depending on a location where the posture detector 20 is mounted.

Such a storage device 10 may include at least one type of storage medium, such as a flash memory type memory, a hard disk type memory, micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The posture detector 20 may be mounted on a dashboard at a driver's seat of the vehicle to detect a posture of the user. In this case, the posture detector 20 may detect a shoulder position of the user as the posture of the user.

For example, FIG. 2A illustrates a shoulder position when the user takes a right posture. FIG. 2B illustrates a shoulder position when the user leans back and is almost in a supine position. FIG. 2C illustrate a shoulder position when the user crouches down in the direction of a dashboard of the vehicle. In this case, an aspect is exemplified as the position of the seat is fixed for illustrative purposes of the present disclosure. However, aspects are not limited thereto. For example, when the position of the seat is changed, the shoulder position of the user should be changed by the changed position of the seat.

Furthermore, as shown in FIG. 3, the posture detector 20 may include a camera 21 and an ultrasonic sensor 22. In this case, the camera 21 may capture an image of the user which sits in the driver's seat such that the posture detector 20 detects a shoulder of the user. Furthermore, the ultrasonic sensor 22 may measure a distance from the user such that the posture detector 20 detects a distance from the shoulder of the user.

Furthermore, the posture detector 20 may detect a hand of the user.

For example, when the user puts his or her hand in an image capture region of the camera 21 with the intention of inputting a gesture, the posture detector 20 may detect the hand of the user from an image captured by the camera 21.

Such a posture detector 20 may be implemented as a driver state warning (DSW) system (not shown) loaded into the autonomous vehicle. For reference, the DSW system may include a camera and an ultrasonic sensor. The DSW system may be mounted on a dashboard at a driver's seat of the vehicle to capture an image (including the shoulder) around an image of the user who sits in the driver's seat and measure a distance from the face and the shoulder, based on the camera and the ultrasonic sensor. In this case, the SW system. may detect the hand of the user from an image captured by the camera.

The gesture detector 30 may recognize the hand of the user on a monitoring region set by the actuator 40 and may detect a gesture by the recognized hand. In this case, the gesture detector 30 may include a camera and an ultrasonic sensor.

Such a gesture detector 30 may be implemented in various forms. However, in an aspect of the present dislosure, a description will be given of an example in which the gesture detector 30 is implemented as a three-dimensional (3D) air gesture detector based on ultrasound haptics.

In one aspect, the ultrasound haptics technology may include an ultrasonic touchless interface technology, and may use an acoustic radiation force rule used to radiate force to one target in mid-air by an ultrasonic transducer.

Such ultrasound haptics technology may ha to track a hand operation of the user using a camera and determine a button the user wants to push. In other words, the 3D air gesture detector may allow a driver to select a desired button in mid-air without touching the screen itself.

Furthermore, the 3D air gesture detector may track a hand operation of the driver using an ultrasound haptics solution form a mid-air touch and may provide tactile feedback. Mid-air touch technology may provide tactility using an ultrasonic wave in a situation there is no any surface touch of the skin of the driver. The tactility may be a feeling pushed with a finger, a tingly sensation of a finger end, or the like.

Meanwhile, the gesture detector 30 may have a monitoring region (a gesture detection region) adjusted by the actuator 40.

For example, as shown in FIG. 2A, when the user sits in a right posture, the monitoring region of the gesture detector 30 may be located around a gear lever. As shown in FIG. 2B, when the user takes a reclining closture, the monitoring region of the gesture detector 30 may be a rear end of the gear lever. As shown in FIG. 2c, when the use slouches, the monitoring region of the gesture detector 30 may be a front end of the gear lever. In this case, the monitoring region may be located in mid-air rather than a contact surface with an object.

The actuator 40 may include a first motor (not shown) for rotating the gesture detector 30 in an x-axis direction and a second motor (not shown) for rotating the gesture detector 30 in a y-axis direction. In other words, the actuator 40 may include the first motor for adjusting the monitoring region of the gesture detector 30 in a left/right direction and the second motor for adjusting the monitoring region of the gesture detector 30 in an upward/downward direction.

Such an actuator 40 may adjust a rotational angle of the gesture detector 30 under control of the control 60. In other words, the actuator 40 may adjust the monitoring region of the gesture detector 30.

The display device 50 may display a function controlled by a gesture of the user in the form of an icon under control of the controller 60.

Furthermore, the display device 50 may display a variety of information generated in the process of adjusting the monitoring region of the gesture detector 30 in consideration of a location of the user in the autonomous vehicle.

The display device 50 may include at least one of a liquid crystal display (LCD), a thin film transistor-LCD (TFT-LCD), an organic light-emitting diode (OLED) display, a flexible display, a three-dimensional (3D) display, or an e-ink display.

Furthermore, the display device 50 may be implemented by means of a display device of an audio video navigation (AVN) system included in the autonomous vehicle.

The controller 60 may perform overall control such that the respective components normally perform their own functions. Such a controller 60 may be implemented in the form of hardware or software or in the form of a combination thereof. In one form, the controller 60 may be implemented as, but is not limited to, a microprocessor.

Furthermore, the controller 60 may perform a variety of control to adjust the monitoring region of the gesture detector 30 in consideration of a location of the user in the autonomous vehicle.

Furthermore, the controller 60 may control the posture detector 20 to capture an image of the user who sits in the driver's seat, recognize a shoulder of the driver from the captured image, and detect a distance from the recognized shoulder of the driver.

In addition, the controller 60 may control the actuator 40 to set the monitoring region of the gesture detector 30 based on the distance from the shoulder of the user, detected by the posture detector 20.

Moreover, the controller 60 may control various control systems and an infotainment system (e.g., a radio, a universal serial bus, Bluetooth, or the like) in the vehicle to recognize the gesture detected by the gesture detector 30 and perform a function corresponding to the recognized gesture.

For example, when a gesture of adjusting a steering wheel of the autonomous vehicle is detected during autonomous driving by the gesture detector, the controller 60 may control an advanced driver assistance system (ADAS) (not shown) to adjust steering of the autonomous vehicle in response to the detected gesture. In this case, the controller 60 may control the display device 50 to display an image shown in FIG. 4A.

For another example, when a gesture of adjusting an interval with a preceding vehicle is detected during autonomous driving by the gesture detector 30, the controller 60 may control a smart cruise control (SCC) system (not shown) to adjust the interval with the preceding vehicle in response to the detected gesture. In this case, the controller 60 may control the display device 50 to display an image shown in FIG. 4B.

For another example, when a gesture of adjusting volume is detected in a situation where the infotainment system (not shown) is operated by the gesture detector 30, the controller 60 may control the infotainment system (not shown) to adjust volume in response to the detected gesture. In this case, the controller 60 may control the display device 50 to display an image shown in FIG. 5A.

For another example, when a gesture of rejecting the reception of a call is detected in a situation where the call is received by the gesture detector 30, the controller 60 may control the infotainment system to reject the reception of the call in response to the detected gesture. In this case, the controller 60 may control the display device 50 to display an image shown in FIG. 5B.

Meanwhile, when a hand of the user is detected by the posture detector 20, the controller 60 may enable the gesture detector 30. When a reference time elapses after enabling the gesture detector 30, the controller 60 may disable the gesture detector 30.

In addition, the gesture interface system of the autonomous vehicle according to an aspect of the present disclosure may further include the seat position detector 70.

When a fault occurs in the posture detector 20 or when a temporary error occurs in the posture detector 20, the seat position detector 70 may detect position information of the driver's seat, used to estimate a shoulder position of the user. In this case, the storage device 10 may further store a table which stores information about a shoulder position of the user, corresponding to the position of the driver's seat.

In other words, the controller 60 may obtain information about the shoulder position of the user, corresponding to the position of the driver's seat, detected by the seat position detector 70 based on the table which stores the information of the shoulder position of the user, corresponding to the position of the driver's seat, stored in the storage device 10. The controller 60 may obtain direction information of the gesture detector 30, corresponding to the obtained shoulder position of the user, based on a table which stores direction information (e.g., x- and y-axis rotational axes) of the gesture detector 30, corresponding to information about the shoulder position of the user, stored in the storage device 10.

Furthermore, the controller 60 may control the actuator 40 such that the obtained direction information is applied to the gesture detector 30.

Such a seat position detector 70 may be implemented as an integrated memory system (IMS) loaded into the autonomous vehicle.

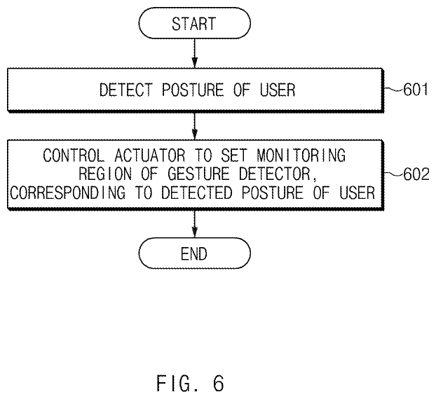

FIG. 6 is a flowchart illustrating an operation method of a gesture interface system of an autonomous vehicle according to an aspect of the present disclosure.

First of all, in operation 601, a posture detector 20 of FIG. 1 may detect a posture of a user.

In operation 602, a controller 60 of FIG. 1 may control an actuator 40 of FIG. 1 to set a monitoring region of a gesture detector 30 of FIG. 1, corresponding to the posture of the user, detected by the posture detector 20.

When the gesture of the user is input in the state where the monitoring region of the gesture detector 30 is set, the controller 60 may recognize the gesture and may control to perform a function corresponding to the recognized gesture.

For example, the controller 60 may receive a gesture of controlling a behavior of the vehicle during autonomous driving. When an infotainment system is operating in a manual driving situation, the controller 60 may receive a gesture of manipulating the infotainment system.

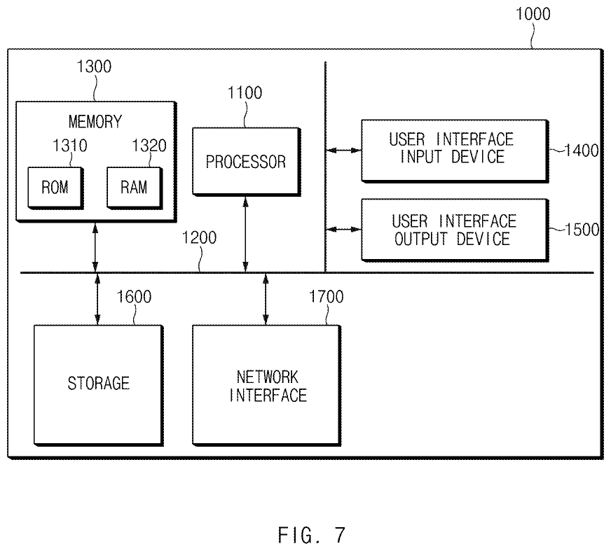

FIG. 7 is a block diagram illustrating a computing system for executing an operation method of a gesture interface system of an autonomous vehicle according to an aspect of the present disclosure.

Referring to FIG. 7, the operation method of the gesture interface system of the autonomous vehicle according to an aspect of the present disclosure may be implemented by means of the computing system. A computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the aspects disclosed herein may be implemented directly in hardware or a software module executed by the processor 1100, or in a combination thereof. The software module may reside on a storage medium (that is, the memory 1300 and/or the storage 1600) such as a RAM memory, a flash memory, a ROM memory, an EPROM memory, an EEPROM memory, a register, a hard disk, a removable disk, a CD-ROM. The storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The above-mentioned technical scope of the present disclosure is sufficiently applicable to a general vehicle as well as the autonomous vehicle.

The gesture interface system of the autonomous vehicle and the operation method thereof may adjust the monitoring region of the gesture detector in consideration of a location and/or posture of the user in the autonomous vehicle to receive a gesture irrespective of whether the user takes any posture.

Hereinabove, although the present disclosure has been described with reference to various aspects and the accompanying drawings, the present disclosure is not limited thereto, but may be variously modified and altered by those skilled in the art to which the present disclosure pertains without departing from the spirit and scope of the present disclosure.

Therefore, aspects of the present disclosure are provided to explain the spirit and scope of the present disclosure, but not to limit them, so that the spirit and scope of the present disclosure is not limited by the aspects.

What is claimed is:

1. A gesture interface system of a vehicle, the gesture interface system comprising:
a posture detector configured to detect a posture of a user;
a gesture detector configured to detect a gesture of the user;
an actuator configured to adjust a monitoring region of the gesture detector; and
a controller configured to control the actuator based on the posture of the user, the posture being detected by the posture detector.

2. The gesture interface system of claim 1, further comprising:
a storage device storing a table which stores direction information of the gesture detector, the direction information corresponding to the posture of the user.

3. The gesture interface system of claim 1, wherein the posture of the user is a posture relative to a shoulder position of the user.

4. The gesture interface system of claim 1, wherein the gesture of the user is a gesture for controlling a behavior of the vehicle.

5. The gesture interface system of claim 4, wherein the gesture of the user is a gesture for manipulating an infotainment system, when the infotainment system included in the vehicle is operating.

6. The gesture interface system of claim 1, wherein the posture detector is mounted on a dashboard at a driver's seat of the vehicle.

7. The gesture interface system of claim 6, wherein the posture detector includes:
a camera configured to capture an image of the user; and
an ultrasonic sensor configured to detect a distance from a shoulder of the user.

8. The gesture interface system of claim 1, wherein the gesture detector is a three-dimensional (3D) air gesture detector based on an ultrasound haptics technology.

9. The gesture interface system of claim 1, wherein the actuator includes:
a first motor configured to adjust the monitoring region of the gesture detector in a left/right direction; and
a second motor configured to adjust the monitoring region of the gesture detector in an upward/downward direction.

10. The gesture interface system of claim 1, further comprising:
a display device configured to display a function controlled by the gesture of the user, wherein the function is represented by an icon.

11. A gesture interface system of a vehicle, the system comprising:
a seat position detector configured to detect a position of a driver's seat of the vehicle;
a gesture detector configured to detect a gesture of a user;
an actuator configured to adjust a monitoring region of the gesture detector; and
a controller configured to estimate a posture of the user based on the position of the driver's seat, the position being detected by the seat position detector, and control the actuator based on the estimated posture of the user.

12. The gesture interface system of claim 11, further comprising:
a storage device storing a first table which stores information about a posture of the user, the posture corresponding to the position of the driver's seat and a second table which stores direction information of the gesture detector, the direction information corresponding to the posture of the user.

13. The gesture interface system of claim 11, wherein the posture of the user is a posture relative to a shoulder position of the user.

14. The gesture interface system of claim 11, wherein the actuator includes:
a first motor configured to adjust the monitoring region of the gesture detector in a left/right direction; and
a second motor configured to adjust the monitoring region of the gesture detector in an upward/downward direction.

15. An method of operating a gesture interface system of a vehicle, the method comprising:
detecting, by a posture detector of the gesture interface system, a posture of a user; and
controlling, by a controller of the gesture interface system, an actuator to set a monitoring region of a gesture detector of gesture interface system, the monitoring region corresponding to the detected posture of the user.

16. The method of claim 15, further comprising:
storing, by a storage device of the gesture interface system, a table which stores direction information of the gesture detector, the direction information corresponding to the posture of the user.

17. The method of claim 15, wherein the posture of the user is a posture relative to a shoulder position of the user.

18. The method of claim 15, wherein the user controls a behavior of the vehicle by a gesture.

19. The method of claim 18, wherein the gesture of the user is a gesture for manipulating an infotainment system, when the infotainment system included in the vehicle is operating.

20. The method of claim 15, further comprising:
adjusting, by the actuator, the monitoring region of the gesture detector in a left/right direction based on the detected posture of the user; and
adjusting, by the actuator, the monitoring region of the gesture detector in an upward/downward direction based on the detected posture of the user.
